(19) United States
(12) Patent Application Publication
(10) Pub. No.: US 2021/0172204 A1
(43) Pub. Date: Jun. 10, 2021

(54) DOOR LOCKING APPARATUS

(71) Applicant: Jon S. Miller dba StopandLock, Castle Rock, CO (US)

(72) Inventors: Jon Steven MILLER, Castle Rock, CO (US); Robert Milton MILLER, Golden, CO (US)

(21) Appl. No.: 17/115,458

(22) Filed: Dec. 8, 2020

Related U.S. Application Data
(60) Provisional application No. 62/946,052, filed on Dec. 10, 2019.

(51) Int. Cl. E05B 53/00; E05B 15/04; E05F 5/02

(52) U.S. Cl. CPC E05B 53/001; E05B 15/04; E05Y 2900/132; E05B 2015/0448; E05B 2015/0496; E05F 5/02

(57) ABSTRACT

The disclosed technology includes a door locking apparatus. In some implementations, the door locking apparatus includes a door stop. In some implementations, the door locking apparatus includes a door block. In some implementations, the door locking apparatus includes a door lock. In some implementations, the door locking apparatus is multi-functional and includes at least one of a door stop, block, and a lock. In some implementations, the door locking apparatus may be operated by a user's foot, although other methods of operation are contemplated. In some implementations, the door locking apparatus may be affixed to either an inside opening door or an outside opening door.

### SUMMARY

The disclosed technology includes a door locking apparatus. In some implementations, the door locking apparatus includes a door stop. In some implementations, the door locking apparatus includes a door block. In some implementations, the door locking apparatus includes a door lock. In some implementations, the door locking apparatus is multi-functional and includes at least one of a door stop, block, and a lock. In some implementations, the door locking apparatus may be fully operated by a user's foot, although other methods of operation are contemplated (e.g., use with a key or a tool). In some implementations, the door locking apparatus may be affixed to either an inside opening door or an outside opening door.

In some implementations, the disclosed technology includes a door locking system including a foot pedal to activate a rod to lock a door in a fixed position when the foot pedal is pressed downward, and a cam lock to hold the rod in place. The fixed position may be the door in a closed position or an open position. In some implementations, the disclosed technology also includes a rod base cap to attach on an end of the rod. In some implementations, the disclosed technology also includes a face plate. The face plate may include an aperture for access to the cam lock housed behind the face plate. In some implementations, the disclosed technology includes the cam lock is configured to activate a rod to unlock a door in a fixed position when the foot pedal is pressed downward

In some implementations, the disclosed technology includes an anti-slam arm configured to rotate from the face plate to contact a door frame to hold the door in an open position.

In some implementations, the disclosed technology includes a key feature (such as an elevator key or first responder key) to be inserted through an aperture in the door to activate the cam lock to unlock the door.

In some implementations, the disclosed technology includes a locking apparatus which comprises a face plate affixed to a door, a spring-loaded foot pedal adapted to activate a rod, the rod to contact a ground surface, and a cam lock adapted to engage and disengage the rod in a fixed position, the cam lock accessible via an aperture located in the face plate. The cam lock may be spring-loaded.

In some implementations, the disclosed technology includes methods for using the locking apparatus or system. Specifically, methods can include locking and unlocking the locking apparatus or system. A method may include pressing a foot pedal in a door locking apparatus downward toward a ground surface, moving a rod connected to the foot pedal downward responsive to pressing the top foot pedal downward, and locking the door locking apparatus in a fixed position responsive to the rod contacting the ground surface. In some implementations, the method may include moving the rod into a pre-drilled hole in the ground surface.

In some implementations, the methods includes pressing on a cam lock to disengage the rod from the pre-drilled hole and move the rod upward into the door locking apparatus, pushing downward on the top foot pedal approximately one inch to contact the ground surface with the rod. The contact with the ground surface may occur at any location on the ground surface where the door travels to hold the door open. The door locking apparatus is configured to attach to at least one of an inside opening door and an outside opening door. In some implementations, the cam lock is a small pedal that is accessible via an aperture on the face plate.

In some implementations, the methods include moving a cam lock from a position approximately perpendicular (e.g., 180°) to the rod to a position approximately angled (e.g., 120°) to the rod to lock the rod into place and/or moving the cam lock from a position approximately angled (e.g., 120°) to the rod to a position approximately perpendicular (e.g., 180°) to the rod to unlock the rod. In some implementations, the method includes pressing a cam lock in a door locking apparatus downward toward a ground surface, and unlocking the door locking apparatus. In some implementations, the methods include inserting a key feature into an aperture located in the door.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various implementations as further illustrated in the accompanying drawings and defined in the appended claims.

These and various other features and advantages will be apparent from a reading of the following Detailed Description.

### BRIEF DESCRIPTION OF THE DRAWINGS

FIGS. 1-3 are an illustration of an example door locking apparatus in a disengaged state.

FIG. 4 is an illustration of an example door locking apparatus in a door-stop engaged state.

FIG. 5 is an illustration of an example door locking apparatus in an anti-slam engaged state.

FIG. 6 is an illustration of an example door locking apparatus in an lock-down engaged state.

FIG. 7 is an illustration of an example door locking apparatus in a lock-down engaged state.

FIG. 8 is an illustration of an example door locking apparatus in a lock-down engaged state.

FIG. 9 is an illustration of an example door locking apparatus in with a first responder key feature in a lock-down engaged state before use.

FIG. 10 is a flowchart of example operations of an example door locking apparatus.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. Similarly, however, no single feature or features of any described implementation should be considered essential to the invention, as other implementations of the invention may omit such features.

The disclosed technology includes a door locking apparatus that may be used for various purposes, such as to lock a door, hold a door open, and keep a door from slamming. The door locking apparatus may include a feature that locks the door in a fixed position. The fixed position may be when the door in a closed position or an open position.

In some implementations, the door locking apparatus may be used in a lockdown situation. For example, if a school or a building has an active shooter situation and there is not enough time for people inside a room to safely exit the room, it may be imperative to lock a door to the room.

The disclosed technology includes a door locking apparatus that enables a door to be lockable from inside a room and in one motion by depressing a foot pedal with the user's foot. The door locking apparatus may include a rod that is pushed down into a rod receptacle in the floor locking the door in place. The door locking apparatus may be unlocked either by someone inside the room, or in some scenarios, by a first responder outside the room. The first responder may use a customized key to access the door locking apparatus via an aperture in the door or other method. To operate the door locking apparatus, a user is not required to use a key or a took although the additional option to do so is available in embodiments that include a first responder key.

In some implementations, the door locking apparatus includes an anti-slam arm that may be used to prevent the door from slamming shut, prevent the door from closing entirely. In some implementations, the door locking apparatus includes a rod that may be pressed down from the door locking apparatus until it contacts a ground surface and holds the door in place.

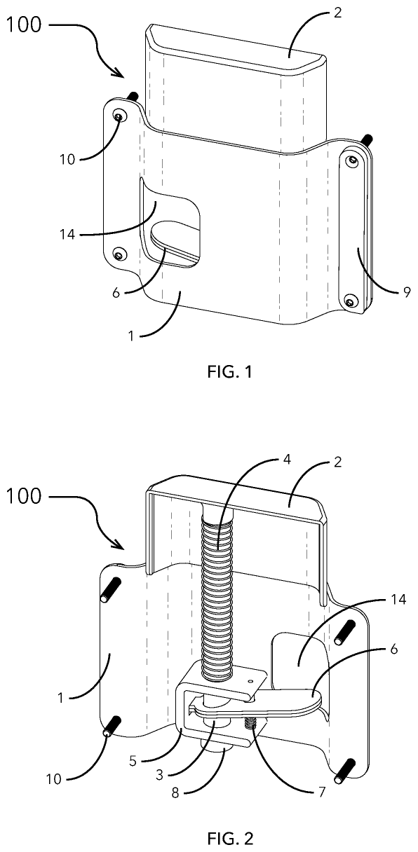

FIG. 1 is an example door locking apparatus 100 in a disengaged state. As shown, the door locking apparatus 100 is assembled for a left hand outswing door. In another implementation, the door locking apparatus 100 may be assembled for a right hand outswing door.

Referring to FIG. 1, an exterior view of a door locking apparatus 100 is shown. In some implementations, the door locking apparatus 100 includes a face plate 1, a foot pedal 2, a cam lock 6, and an anti-slam arm or door block pedal 9. An aperture 14 is located in the face plate 1 for access to the cam lock 6. As shown in the FIG. 1, door mounting screws 10 may be used to affix the door locking apparatus 100 to the door. Other methods of affixing the door locking apparatus 100 to the door are contemplated.

Referring to FIG. 2, an interior view of a door locking apparatus 100 is shown. In some implementations, the door locking apparatus 100 includes a rod 3, a rod spring 4, a rear block 5, a cam lock spring 7, and a rubber foot 8. The rubber foot 8 may be located on the end of the rod 3. In some implementations, the rod 3 does not have a rubber foot 8.

The rod spring 4 surrounds the rod 3 at the middle and top portion of the rod 3, although it may vary in size. The rod 3 locates through the rear block 5 and the cam lock 6. The rubber foot 8 may be located on the end of the rod 3. the cam lock spring 7 is located between the rear block 5 and the cam lock 6, providing a springing mechanism for the cam lock 6.

The door locking apparatus 100 may be made of various heavy duty materials (e.g., heavy duty metal, stainless steel, etc.)

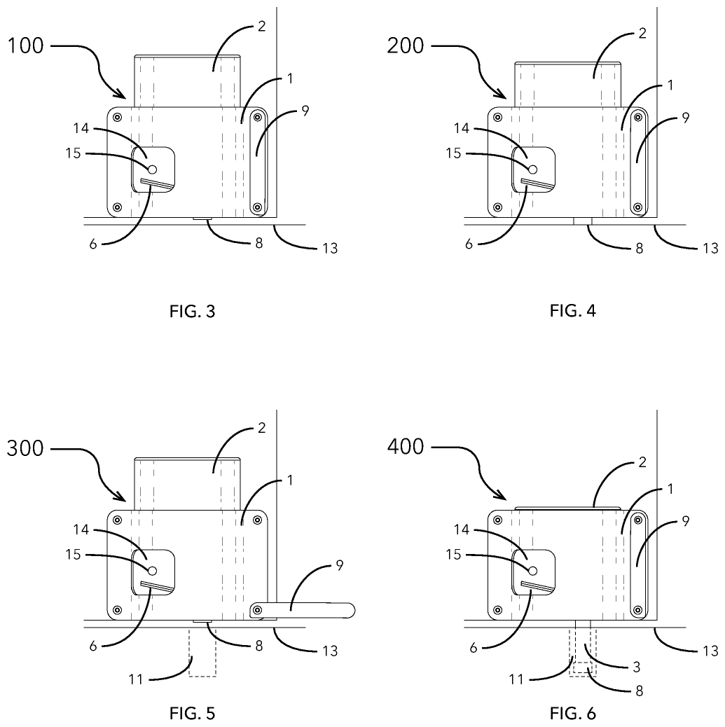

Referring to FIGS. 3-6, example door locking apparatus 100, 200, 300, and 400 are shown attached to a door and located over a ground surface 13. The rod 3 of the door locking apparatus 100, 200, 300, and 400 has a rubber foot 8 located on the bottom of the rod 3. As shown, the door locking apparatus 100, 200, 300, and 400 are assembled for a left hand outswing door. In another implementation, the door locking apparatus 100, 200, 300, and 400 may be assembled for a right hand outswing door.

FIG. 3 shows the door locking apparatus 100 before use in a disengaged state. Before use, the foot pedal 2 extends up from and behind the face plate 1. During use, the foot pedal 2 may be pressed in a downward direction toward the ground surface 13 for engagement of the door locking apparatus 100. As the foot pedal 2 is pressed downward, the rod 3 attached to the foot pedal 2 moves downward in the rod spring 3, which collapses. The cam lock 6, which is spring-loaded with the cam lock spring 7, surrounds the rod 3 inside the rear block 5. The cam lock 6 locks the rod 3 in place as the cam lock moves in a direction angled to the rod 3, placing a resistance on the rod 3.

FIG. 4 is an example door locking apparatus 200 in a door-stop engaged state. As shown, the door locking apparatus 200 is assembled for a left hand outswing door. In another implementation, the door locking apparatus 200 may be assembled for a right hand outswing door.

In some implementations, as shown in FIG. 4, during use, as the foot pedal 2 is pressed and moves downward, the foot pedal 2 pushes the rod 3 down toward the ground surface 13, in an engaged state. When the rod 3, or more specifically, the rubber foot 8 in FIG. 4 contacts the ground surface 13, the rod 3 acts as door stop and holds the door in position and prevents the door from moving. For example, the foot pedal 2 may be pushed down approximately one inch to for the rod 3 to make contact with the ground surface 13. Such distance facilitates a door stop function whereby the door can be held open in a fixed position at any point in the range of the door opening.

FIG. 5 is an example door locking apparatus 300 in an anti-slam engaged state. As shown, the door locking apparatus 300 is assembled for a left hand outswing door. In another implementation, the door locking apparatus 300 may be assembled for a right hand outswing door.

During use, the anti-slam arm 9 may be rotated in various positions. In some implementations, the anti-slam arm 9 may be rotated from a vertical position to a horizontal position, approximately 90 degrees and act as a door stop by locating between the door and a door hinge when the door is nearly closed in a door-stop engaged state. In some implementations, the anti-slam arm 9 may be disengaged, thereby removing the door-stop mechanism, by rotating the anti-slam arm 9 from a horizontal position to a vertical position a, approximately 90 degrees. In some implementations, the anti-slam arm 9 may rotated from a vertical position beyond a horizontal position, rotating approximately 100-120°. The anti-slam arm 9 may be made of various materials (e.g., plastic, heavy gauge rubber, metal (stainless steel)-rubber coated, etc.).

FIG. 6 is an example door locking apparatus 400 in an lock-down engaged state. As shown, the door locking apparatus 400 is assembled for a left hand outswing door. In another implementation, the door locking apparatus 400 may be assembled for a right hand outswing door.

In some implementations, as shown in FIG. 5, during use, as the rod 3 is pressed downward, the rod 3 enters a rod receptacle 11. In some implementations, the rod receptacle 11 may be a pre-drilled hole located in the ground. In other implementations, the rod receptacle 11 may be a tube or a casing inserted into a pre-drilled hole located in the ground. The rod receptacle 11 may be located approximately at the intersection of a room and another room or hallway so that when the door is in a closed position, the rod 4 locks the door in the closed position when it enters the rod receptacle 11.

The size of the rod 4 and the depth of the rod receptacle 11 may vary depending on the implementation. In one example, the rod 4 may be ⅞ inch stainless steel, and may be insert into the floor at an approximate depth up to 3.5 inches. In another example, the rod 4 may be a ¾ inch steel rod is inserted into the floor at an approximate depth of three inches in the rod receptacle 11. The rod receptacle 11 depth may vary with the installation on the door and the size of the gap of the door above the ground.

The cam lock 6 is adapted to engage and disengage the rod in a fixed position. To unlock the door, the cam lock 6 may be pressed downward to disengage the rod 3 from the ground surface 13 or the rod receptacle 11. In some implementations, the cam lock 6 may be accessed via an aperture 14 located in the face plate 1 and depressed to unlock the locking apparatus 400. As the cam lock 6 is pushed down onto the cam spring 7, the cam lock 6 moves from a position angled to the rod 3 to a position that is approximately perpendicular to the rod 3, and relieving tension and lock on the rod 3. As a result, the rod 3 can move upward and unlock the door locking apparatus from a door stop or door lock engaged state.

In some implementations, the door locking apparatus 100, 200, 300, and 400 may be affixed to either an inside opening door or an outside opening door.

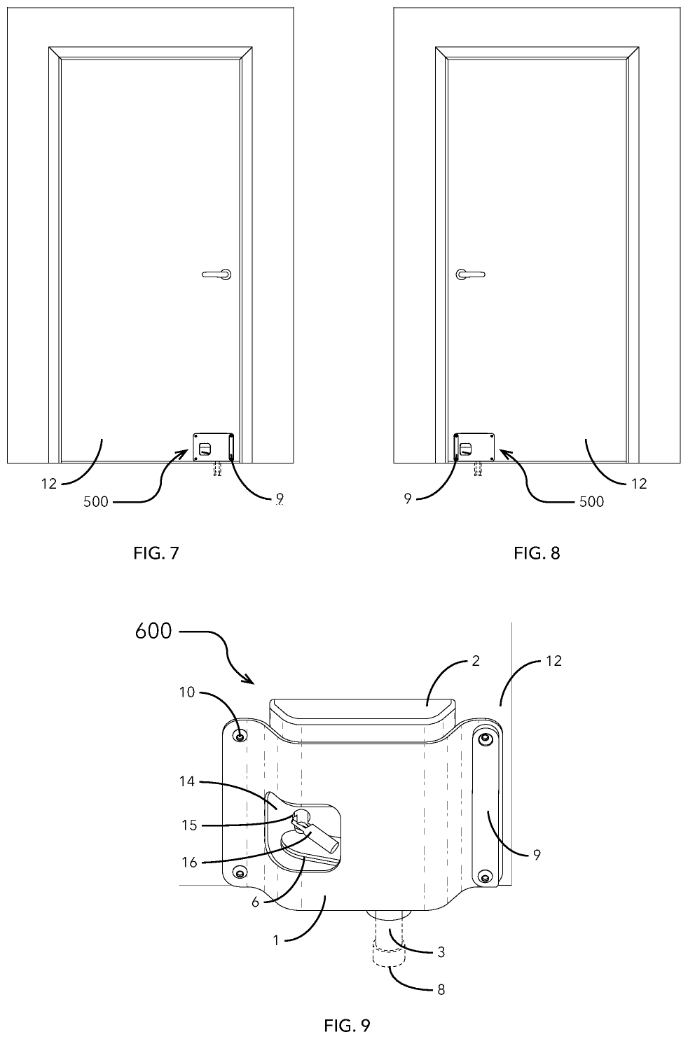

FIGS. 7 and 8 are illustrations of example door locking apparatus 500 in a lock-down engaged state. More specifically, FIGS. 7 and 8 show the example door locking apparatus illustrated in FIG. 6 in use with doors. The door locking apparatus 500 shown in FIG. 7 is assembled for a left-hand outswing door 12. The door locking apparatus 500 shown in FIG. 8 is assembled for a right-hand outswing door 12.

FIG. 9 is an illustration of an example door locking apparatus 900 with a first responder key 16 in a lock-down engaged state before use. Several first responder key features and methods of using a first responder key feature are contemplated. In some implementations, a locking system may include a door locking apparatus 900 with a key access. The key access may be located on the door on the opposite side on which the door locking apparatus 100 is located. The first responder may approach the door on the side opposite the door locking apparatus and unlock the door locking apparatus via a keyhole or aperture in the door and access the door locking apparatus.

For example, the key access may be a “first responder key,” utilized by first responders when the door has been locked with the door locking apparatus 100. In some cases, the first responder key may operate as a modified elevator key.

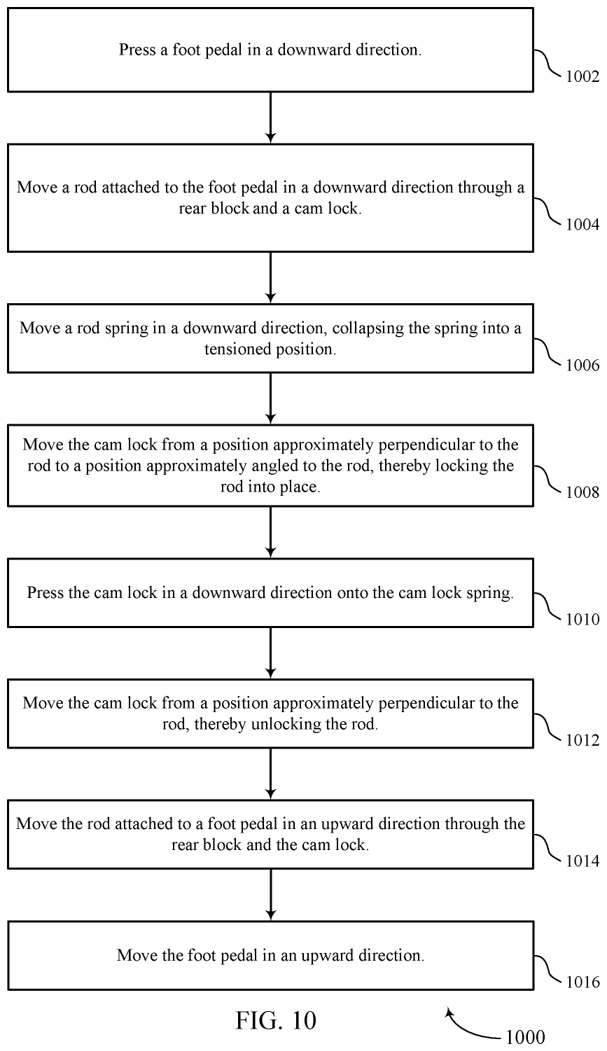

FIG. 10 is a flowchart of example operations 1000 of an example door locking apparatus. Operations 1002-1008 are directed to locking the locking apparatus. An operation 1002 presses the foot pedal in a downward direction. An operation 1004 moves the rod attached to the foot pedal in a downward direction through the rear block and the cam lock. An operation 1006 moves the rod spring in a downward direction, collapsing the spring into a tensioned position. An operation 1008 moves the cam lock from a position approximately perpendicular (e.g., 180°) to the rod to a position approximately angled (e.g., 120°) to the rod, thereby locking the rod into place. In some implementations, the rod may be locked into place in a position contacting a ground surface. In some implementations, the rod may be locked into place in a position inside a rod receptacle in the floor.

Operations 1010-1016 are directed to unlocking the locking apparatus. An operation 1010 presses the cam lock in a downward direction onto the cam lock spring. In some implementations, the cam lock may be accessed via an aperture in the face plate. In some implementations, the cam lock may be accessed via an aperture in a door, as shown and described in FIG. 9. For example, a user may use a first responder tool through the aperture in the door to access the cam lock. In some implementations, the cam lock may be accessed via a key and key hold in a door.

An operation 1012 moves the cam lock from a position approximately angled (e.g., 120°) to the rod to a position approximately perpendicular (e.g., 180°) to the rod, thereby unlocking the rod. An operation 1014 moves the rod attached to the foot pedal in an upward direction through the rear block and the cam lock. An operation 1016 moves the foot pedal in an upward direction.

The logical operations making up the embodiments of the invention described herein are referred to variously as operations, steps, objects, or modules. Furthermore, it should be understood that logical operations may be performed in any order, adding or omitting operations as desired, unless explicitly claimed otherwise or a specific order is inherently necessitated by the claim language.

The above specification, examples, and data provide a complete description of the structure and use of exemplary embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

We claim:

1. A door locking system comprising:
a foot pedal to activate a rod to lock a door in a fixed position when the foot pedal is pressed downward; and
a cam lock to hold the rod in place.

2. The door locking system of claim 1, wherein the fixed position is the door in a closed position.

3. The door locking system of claim 1, wherein the fixed position is the door in an open position.

4. The door locking system of claim 1, further comprising:
a rod base cap to attach on an end of the rod.

5. The door locking system of claim 1, further comprising:
a face plate, the face plate including an aperture for access to the cam lock housed behind the face plate.

6. The door locking system of claim 1, further comprising:
an anti-slam arm configured to rotate from the face plate to contact a door frame to hold the door in an open position.

7. The door locking system of claim 1, further comprising:
a key feature to be inserted through an aperture in the door to activate the cam lock to unlock the door.

8. The door locking system of claim 1, wherein the cam lock is configured to activate a rod to unlock a door in a fixed position when the foot pedal is pressed downward.

9. A method comprising:
pressing a foot pedal in a door locking apparatus downward toward a ground surface;
moving a rod connected to the foot pedal downward responsive to pressing the top foot pedal downward; and
locking the door locking apparatus in a fixed position responsive to the rod contacting the ground surface.

10. The method of claim 9, further comprising:
moving the rod into a pre-drilled hole in the ground surface.

11. The method of claim 9, further comprising:
pressing on a cam lock to disengage the rod from the pre-drilled hole and move the rod upward into the door locking apparatus.

12. The method of claim 9, further comprising:
pushing downward on the top foot pedal approximately one inch to contact the ground surface with the rod.

13. The method of claim 12, wherein the contact with the ground surface may occur at any location on the ground surface where the door travels to hold the door open.

14. The method of claim 9, wherein the door locking apparatus is configured to attach to at least one of an inside opening door and an outside opening door.

15. The method of claim 9, wherein the cam lock is a small pedal that is accessible via an aperture on the face plate.

16. The method of claim 9, further comprising:
moving a cam lock from a position approximately perpendicular (e.g., 180°) to the rod to a position approximately angled (e.g., 120°) to the rod to lock the rod into place.

17. The method of claim 16, further comprising:
moving the cam lock from a position approximately angled (e.g., 120°) to the rod to a position approximately perpendicular (e.g., 180°) to the rod to unlock the rod.

18. The method of claim 9, further comprising:
inserting a key feature into an aperture located in the door;
pressing a cam lock in a door locking apparatus downward toward a ground surface; and
unlocking the door locking apparatus.

19. A locking apparatus comprising:
a face plate, the face plate affixed to a door;
a spring-loaded foot pedal adapted to activate a rod,
the rod to contact a ground surface; and
a cam lock adapted to engage and disengage the rod in a fixed position, the cam lock accessible via an aperture located in the face plate.

20. The locking apparatus of claim 19, wherein the cam lock is spring-loaded.
